(19) United States
(12) Patent Application Publication
(10) Pub. No.: US 2014/0192478 A1
(43) Pub. Date: Jul. 10, 2014

(54) METHODS AND APPARATUS FOR THE RETENTION OF A PERSONAL ELECTRONIC DEVICE WITHIN A PHYSICAL INTERACTION DEVICE

(71) Applicant: Physical Apps, LLC, Hollis, NH (US)

(72) Inventor: Robert C. Houvener, Hollis, NH (US)

(73) Assignee: Physical Apps, LLC, Hollis, NH (US)

(21) Appl. No.: 14/103,996

(22) Filed: Dec. 12, 2013

Related U.S. Application Data
(60) Provisional application No. 61/750,068, filed on Jan. 8, 2013.

(51) Int. Cl. G06F 1/16

(52) U.S. Cl. CPC G06F 1/1632
USPC 361/679.41; 29/592.1

(57) ABSTRACT

A retention apparatus configured to retain a personal electronic device within a protective device may include a personal electronic device retention element including two or more retention loops, where the two or more retention loops comprise flexible material, and each retention loop of the two or more retention loops is configured to stretch over and secure a portion of a personal electronic device. The retention apparatus may further include a retention strap configured to releasably connect the retention apparatus to an exterior shell of the protective device, where the retention apparatus is configured to replaceably receive the personal electronic device during connection of the retention strap to the exterior shell of the protective device.

### BACKGROUND

Examples of personal electronic devices include smart phones, multi-media players, portable music players, digital cameras, handheld gaming systems, and other devices for communication and entertainment. Some personal electronic devices are capable of wirelessly connecting to a network, for example via Wi-Fi™ or a cellular carrier. Personal electronic devices may include one or more features such as voice recognition, voice based control, motion sensing, location sensing, one or more microphones, one or more speakers, one or more video and/or audio outputs, and input mechanisms such as QWERTY keyboard controls, buttons, track balls, and touch screen control elements.

Various case technology has been developed to protect personal electronic devices from damage, for example due to being dropped, scratched, or exposed to conditions that could harm the internal circuitry. Docking stations and other apparatus for releasably retaining personal electronics have also been developed, for example to enable power charging of the personal electronic device or to connect the personal electronic device to peripheral technology, such as audio speakers.

### SUMMARY

In one aspect, the present disclosure describes a protective device that includes retention apparatus for releasably connecting a personal electronic device to the exterior shell of the protective device. The protective device may include at least one of an open cell foam, a closed cell foam, a foamed resin, and an inflatable bladder. The retention apparatus may include at least one of rubber, hook and loop material (such as Velcro®), synthetic elastomers and non-elastomers, natural materials such as leathers, fibers as commonly used in ropes, metals, magnetic materials and advanced synthetic fibers such as carbon fibers. The retention apparatus may involve one or more methods of attachment, the one or more methods of attachment performing in a primary, secondary or other capacity in retaining or securing the personal electronic device in place while the protective device is in use. The retention apparatus of the protective device may further be configured to protect one or more of a user interacting with the protective device and the surroundings in which the protective device is being used (e.g., furniture, personal belongings, bystanders, etc.) during physical activity by reducing the probability that the personal electronic device will be ejected from the protective device. The protective device may include at least one of weight training exercise equipment, combat-training exercise equipment, balance and coordination training exercise equipment, or sports game equipment.

The retention apparatus may be configured in one or more pieces and may be releasably attached to the personal electronic device in one or more places. The protective device may include an interior receptacle for receiving the personal electronic device (plus, optionally, at least a portion of the retention apparatus). The exterior shell of the protective device may include a first portion and a second portion, the first portion closing against the second portion to substantially enclose the personal electronic device, the exterior shell being configured to receive the personal electronic device within the personal electronic device receptacle when the first portion is at least partly separated from the second portion. The exterior shell may include a number of perforations. The exterior shell may include a window area configured to provide visual access to a portion of a screen area of the personal electronic device when the personal electronic device is substantially enclosed within the protective device. The exterior shell may define a volume at least three times as large as a volume of the personal electronic device.

### BRIEF DESCRIPTION OF THE FIGURES

The foregoing and other objects, aspects, features, and advantages of the present disclosure will become more apparent and better understood by referring to the following description taken in conjunction with the accompanying drawings, in which:

FIG. 1A is a diagram of an example retention apparatus for retaining a personal electronic device within a protective device;

FIG. 1B is a diagram of an example strap for use with a retention apparatus for retaining a personal electronic device within a protective device;

FIG. 2 is a diagram of another example retention apparatus for retaining a personal electronic device within a protective device;

FIG. 3 is a diagram of an example retention apparatus including finger holds for aid in securing a personal electronic device to the retention apparatus;

FIGS. 4A and 4B illustrate example strap configurations including voids for controlling elasticity;

FIGS. 5A through 5D illustrate the configuration and installation of an example retention apparatus assembly with an accessory block;

FIGS. 6A and 6B illustrate additional example retention apparatus assembly configurations;

FIGS. 7A through 7C illustrate example activities involving a personal electronic device releasably retained within a protective device;

FIG. 8 illustrates a retention assembly including one or more offsetting weights;

FIG. 9 is a flow chart of an example method for assembling and using a retention assembly; and

FIG. 10 is a block diagram of a computing device and a mobile computing device.

The features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

In some implementations, the present disclosure may be directed towards methods and apparatus for retaining a personal electronic device in a protective device. Related application Ser. No. 13/348,433, filed on Jan. 11, 2012, and titled “Physical Interaction Device for Personal Electronics and Method for Use” and Ser. No. 13/348,434, filed on Jan. 11, 2012, and titled “Physical Interaction Device for Personal Electronics and Method for Use”, each of which is hereby incorporated by reference, describe various protective devices which may each make use of various methods and apparatus described herein to aid in retaining a personal electronic device. Although the related applications include various methods and apparatus for physically retaining a personal electronic device, the apparatus and methods described herein may be used in lieu of or in addition to these methods and apparatus, for example in order to provide an additional safety mechanism in certain usage scenarios, such as when very aggressive movement of the protective device may be anticipated, especially when utilized by users with significant physical strength. As such, the present disclosure provides robust primary, secondary and/or other methods and apparatus for retaining a personal electronic device within a protective device, thereby reducing the probability of damage to the personal electronic device, users or surroundings. For example, in the event that a user propels a protective device containing a personal electronic device, causing the protective device to strike another object, a primary retaining method or apparatus may fail to retain the personal electronic device in stowed position within the protective device. The secondary or additional retaining method or apparatus, in this circumstance, would prevent the personal electronic device from separating from the protection device.

In some implementations, the retention apparatus and retention assemblies described herein are configured for toolless installation and removal. For example, a user may install the retention apparatus by hand without damage or modification to the protective device and/or the personal electronic device. The user may then remove and replace the personal electronic device with ease, for example to accept phone calls, install additional software applications, or launch additional features of the personal electronic device. The retention apparatus and assemblies, for example, may be configured to allow a typical adult user to release the personal electronic device from the retention apparatus within a matter of one to three minutes, or in one minute or less. In other implementations, a tooled or toolless (e.g., combination lock) retention lock may be added, for example to ensure that a small child will not be capable of easily removing the personal electronic device from the protective device upon installation.

The personal electronic device may be retained within the protective device, in some implementations, using retention apparatus for releasably connecting the personal electronic device to the protective device or to a protective enclosure thereof. The protective device, in some examples, may include at least one of an open cell foam, a closed cell foam, a foamed resin, and an inflatable bladder. The retention apparatus, in some examples, may include at least one of rubber, hook and loop material (such as Velcro®), synthetic elastomers and non-elastomers, natural materials such as leathers, fibers as commonly used in ropes, metals, magnetic materials and advanced synthetic fibers such as carbon fibers.

In some implementations, retaining the personal electronic device within the protective device involves one or more methods of attachment, the one or more methods of attachment providing a primary, secondary or other level of functionality in retaining or securing the personal electronic device in place while a user is interacting with the protective device. The retention apparatus of the protective device may further be configured to protect one or more of a user interacting with the protective device and a surroundings of the protective device during physical activity by reducing the probability that the personal electronic device will be ejected from the protective device. The retention apparatus, in some implementations, is configured in one or more pieces. The retention apparatus, in some implementations, is configured to be releasably attached to the personal electronic device in one or more places.

The exterior shell of the protective device, in some implementations, includes a slot, deformable slit, cavity, or other opening for receiving the personal electronic device. The interior of the protective device, in some implementations, includes a personal electronic device receptacle configured to receive a variety of sizes of personal electronic devices (plus, optionally, at least a portion of the retention apparatus). The receptacle, in some implementations, includes a deformable material configured to receive a variety of sizes of personal electronic devices. In some implementations, the receptacle includes one or more connection points configured for connection to retention apparatus. The receptacle, in some implementations, is a hollow region within the protective device. In some implementations, the receptacle is part of a protective encasement portion of the protective device.

In some implementations, the exterior shell of the protective device includes a first portion and a second portion, the first portion closing against the second portion to substantially enclose the personal electronic device, the exterior shell being configured to receive the personal electronic device within a personal electronic device receptacle when the first portion is at least partly separated from the second portion. In other implementations, the first portion and the second portion are part of the design for manufacturability and are permanently secured to each other as part of the manufacturing process. The exterior shell may include a number of perforations. The exterior shell may include a window area configured to provide visual access to a portion of a screen area of the personal electronic device when the personal electronic device is substantially enclosed within the device. The exterior shell may define a volume at least three times as large as a volume of the personal electronic device.

In some implementations, the personal electronic device may be encased in a protective encasement of a protective device. A physically protective, light weight and cost-effective covering or encasement for a personal electronic device, in some implementations, may enable use of an off-the-shelf personal electronic device as a game play and learning system. A personal electronic device, in some examples, may include a handheld consumer electronic device, cellular phone, smart phone, multimedia device, personal entertainment device, handheld gaming device, personal digital assistant, or other small computing device.

In some implementations, a personal electronic device may be positioned in a protective enclosure of a protective device to encourage physical interaction with the personal electronic device, without the fear of injury or harm to the personal electronic device itself, to players or surroundings.

The protective device and/or protective encasement, in some implementations, may be constructed of any material capable of absorbing physical shock, thereby protecting the personal electronic device. In some implementations, the protective device may additionally absorb physical shock in a manner that protects users interacting with the protective device as well as the surroundings. In some examples, construction materials of the protective device may include closed cell foams, open cell coated foams, and/or inflatable chambers. A protective chamber region of the protective device, in some implementations, may protect the device from environment damage (e.g., sand, dust, water, snow, etc.), for example by providing a waterproof seal.

In some implementations, a personal electronic device may be encased in a protective enclosure of a protective device to provide protection to the personal electronic device during physical gaming (e.g., where the personal electronic device may be moved about at high velocity, thrown, or shaken). For example, a personal electronic device may be encased in a ball-shaped protective enclosure during a game of media rich “hot potato” where the ball-shaped protective device is tossed from person to person until an indication of game end is presented (e.g., alarm goes off, music stops playing, etc.).

In some implementations, the protective device may include a volume substantially larger than the protective enclosure. For example, the protective device may have a volume at least three times as large as a volume of the personal electronic device. The volume of the protective device, in some implementations, may be substantially hollow, for example allowing the protective device to be light weight or to encourage air flow around a portion of the personal electronic device to aid in cooling of the personal electronic device while encased in the protective enclosure of the protective device.

To engage in interactive play via the personal electronic device encased in the protective device, in some implementations, a user may execute a software application installed in part upon the personal electronic device. In some examples, the software application may come pre-installed upon the personal electronic device, or the user may download the software application from directly connected (e.g., removable memory drive) or networked media storage. In some implementations, the protective device may be sold with one or more software applications or with instructions for accessing one or more software applications designed to enhance the use of the protective device.

In some implementations, a user may visit a web site to shop for and purchase one or more software applications designed for interactive play with a personal electronic device installed within a protective device. For example, via a browsing mechanism available on the personal electronic device or other personal computing device, a user may select one or more software applications to install upon the personal electronic device.

In some implementations, a user may access a software application interface to configure or personalize a software application for use with the protective device. For example, a user may be provided the opportunity to customize an application (e.g., audio settings or custom audio files, video settings or custom video files, voice recognition settings, data collection settings, etc.) through the personal electronic device, or through a web site or online application accessible via another personal computing device. In a particular example, a teacher may select or input a set of trivia questions or spelling words to be used in a physical learning game in a classroom environment. For example, a ball-shaped protective device may be tossed between students, where the student is asked one of a series of questions when the ball is caught. In some implementations, the particular question asked may be based in part upon an orientation of the personal electronic device within the ball-shaped protective device. The questions, in some implementations, may be provided in a randomized order. In some implementations, the questions may be displayed upon a screen area of the personal electronic device which is visible to the student. The question, in some implementations, may be asked audibly, for example through one or more speakers built into the personal electronic device or in communication with the personal electronic device.

In some implementations, a user may be provided the opportunity to build an application configured for interaction with the protective device and to install the application upon the personal electronic device. For example, a user may select and customize existing modules to create a unique software application for interaction with the protective device.

A same software application may be installed upon two or more personal electronic devices, in some implementations, such that the two or more personal electronic devices may each be used in interactive play, each of the two or more personal electronic devices being inserted into a respective protective device. For example, the two or more personal electronic devices may share data via a wireless network connection during interactive play to provide near real-time interaction between the two personal electronic devices. In some implementations, the two or more personal electronic devices may be located in remote locations. For example, a first player in a first geographic location may engage in an interactive game with a second player in a second geographic location.

In some implementations, one or more electronically coupled devices, such as external speakers, microphones, display devices, and remote control devices (e.g., installed interior and/or exterior to the protective enclosure) may be included as part of the media-rich experience provided by the protective device. One or more electronically coupled devices, in some implementations, may be positioned external to the protective device and connected to the personal electronic device and/or the protective device via a wired or wireless connection. In some implementations, one or more peripheral devices may be installed within the protective device and directly or wirelessly connect to the personal electronic device.

In some implementations, the protective device may include no additional electronics beyond the personal electronic device. For example, an existing personal electronic device may be placed within a protective enclosure of a protective device and a user may access the capabilities of the personal electronic device to engage in a game or learning experience via, for example, a software application executing in part upon the personal electronic device.

In some implementations, a software application running on the personal electronic device may wirelessly communicate with one or more networked devices (e.g., a tablet, laptop, television, digital display, audio speaker, etc.) to enhance and expand the user experience. Further to the example, in some implementations, user data may be stored on the personal electronic device, a networked user device, or in remote network storage (e.g., within an application cloud) for access and use by the user of the personal electronic device or by others (e.g., a coach, doctor, parent, etc.) interested in monitoring data collected via the personal electronic device. Stored data, in some examples, may be accessed in real time or collected and reviewed as historical data.

In some implementations, a personal electronic device may be encased in a protective enclosure of a protective device to enable a user with physical and/or mental limitations to more easily or more safely interact with the personal electronic device. In some implementations, the protective enclosure may be designed for interaction with small children, elderly persons, those with forms of physical ailments such as recoveries from bone or muscle injuries, those with long term physical ailments such as multiple sclerosis etc, and those with forms of dementia.

In some implementations, a patient may utilize a personal electronic device enclosed in a protective enclosure of a protective device to perform rehabilitating work while data regarding progress and/or results of rehabilitative tasks accomplished via the personal electronic device may be recorded and utilized by the user and/or those assisting the user in their rehabilitative activities. In a particular example, a rehabilitative professional may access the data (e.g., via a user interface such as a web page) to review activities that a patient performed. Data collected during interaction with a personal electronic device encased in a protective device, in some implementations, may include detailed statistics recorded by one or more software applications executed in part upon the personal electronic device.

In some implementations, a personal electronic device may be enclosed in a protective enclosure of a protective device to facilitate interaction with the personal electronic device during physical exercise. In some implementations, the protective device may be designed as a piece of exercise equipment, similar to a heavy exercise ball (e.g., medicine ball, kettle), barbell, dumbbell, liquid or gel-weighted shape, or other weight training exercise equipment; a boxing glove, heavy bag, speed bag, standing heavy bag, virtual sparring partner, or other combat-training exercise equipment; a stability disc, wobble board, yoga ball, or other balance and coordination training exercise equipment; or a playground ball, football, basketball, soccer ball, flying disc, baseball bat, or other sports game equipment or recreational equipment. In some implementations, software functioning in part on the personal electronic device may be used to coach a player during physical exercise or track performance during an exercise workout. In some examples, sensors such as an accelerometer, positioning sensor, orientation sensor, global positioning sensor, gyroscope, light sensor, imaging sensor, acoustic sensor, microphone, camera, or other external sensing device may provide data to software functioning in part on the personal electronic device to determine behaviors (e.g., velocity, trajectory, rotational speed) of the protective device or of the user during physical exercise.

In some implementations, a personal electronic device may be enclosed in a protective enclosure of a protective device to facilitate multi-media rich imaginative play. For example, a personal electronic device may be installed within a protective device designed as a child's toy. One or more sensors within or communicating with the personal electronic device, for example, may provide input to a software application regarding a child's interactions with the toy. In response to sensed interactions, in some examples, the software application may output lights, colors, images, audio, video, vibrations, or other feedback responsive to the child playing with the toy.

While a personal electronic device is encased in a protective device, in some implementations, a user may control the personal electronic device via voice commands. For example, a voice recognition component of the personal electronic device may recognize one or more commands to control the personal electronic device and/or one or more software applications providing a media-rich interactive experience with the protective device via the personal electronic device. Commands, in some examples, may include launching of one or more software applications, configuring one or more software application options, and configuring device options (e.g., volume control, power off, etc.).

In some implementations, a software application executing upon the personal electronic device may determine the identity of a particular player interacting with the personal electronic device. Player identification, in some implementations, may be accomplished via a touch input, such as via one or more button inputs or virtual control inputs such as a virtual keyboard rendered on a screen area of the personal electronic device. In other implementations, the software may utilize one or more biometric identification techniques, such as voice, facial feature, or fingerprint recognition, for example utilizing one or more sensors and/or sensor input applications. For example, biometric identification techniques may be available on the personal electronic device or through software modules accessible via one or more computer networks accessible to the personal electronic device. In some implementations, player identification may be accomplished while the personal electronic device is encased in a protective device. In some implementations, one or more unique identifiers may be mapped to a particular game player such as, in some examples, barcodes or radio-frequency identification (RFID) chips provided in or on a wrist band, card, or other separate identification mechanism. In some implementations, a user may download a unique game player code to the personal electronic device, and the software may access the unique game player code within a memory location of the personal electronic device to identify the game player.

Similarly, in some implementations, the individual protective device may be identified by one or more software applications executing on the personal electronic device. For example, one or more printed bar codes, radio frequency identification chips, or other unique identifiers may be included within or upon the protective device, enabling either a general identification (e.g., round ball versus football) or a unique identification (e.g., individually-purchased item) of the protective device. In some implementations, the personal electronic device may be used to read an identifying marker, for example by using one or more sensors such as a bar code reader, camera, imaging system, or RFID sensor resident to the personal electronic device. The personal electronic device, in some implementations, may utilize the identifying information to customize user experience, for example during game play or other interaction.

In some implementations, recognition of a type of protective device, a uniquely identified protective device, and/or a uniquely identified game player may be used to customize and enhance presentation of one or more games for use with the protective device. In some implementations, unique audio, graphic, or video input may be provided based in part upon identification of the protective device. For example, upon recognition that the protective device was sold with an exterior design of a licensed character, catch phrases of the licensed character, a voice of the licensed character, and/or one or more images or videos of the licensed character may be provided to the game player during interactive play. In some implementations, unique identification of a user may allow the software application to store information (e.g., high score, preferences, historical performance data, etc.) associated with the unique user on the personal electronic device and/or at a remote storage location on a computer network accessible to the personal electronic device.

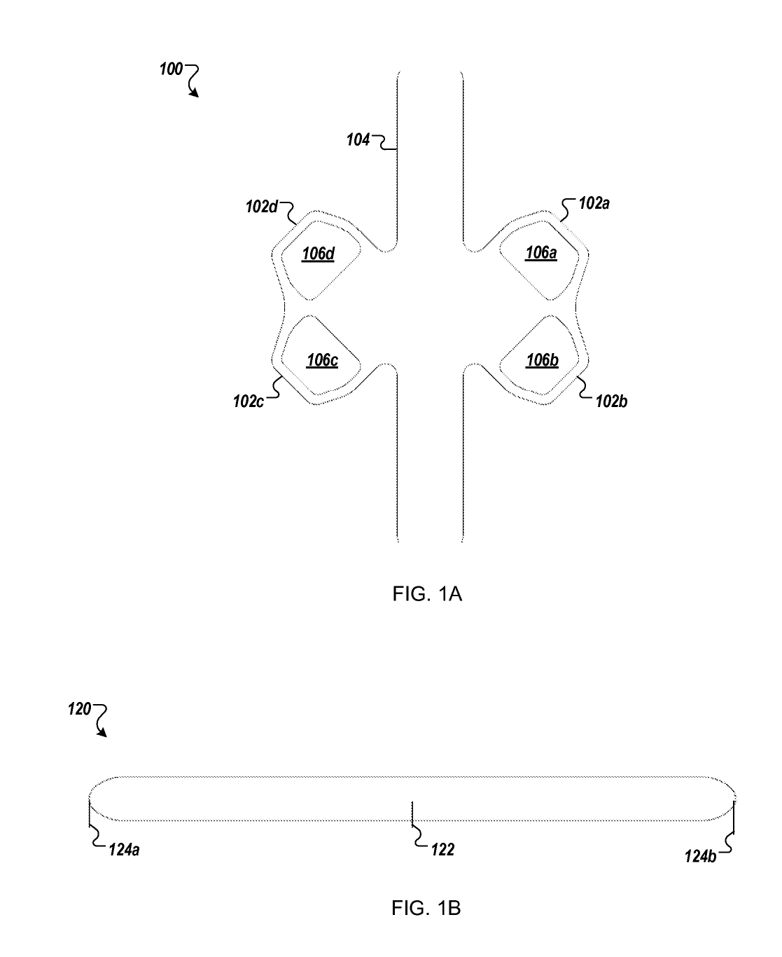

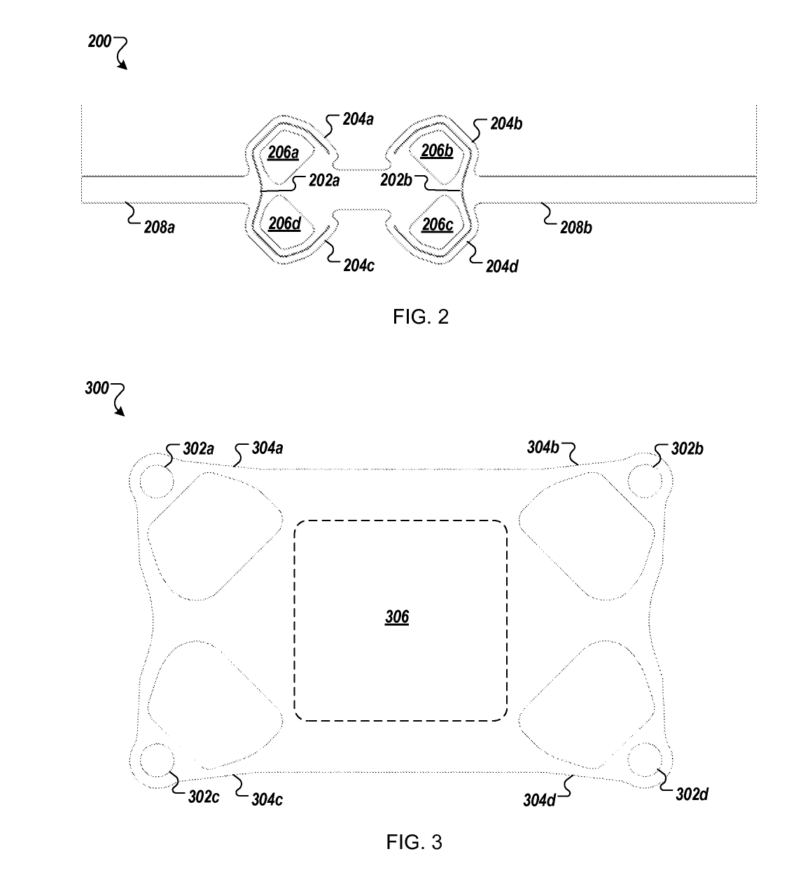

Turning now to FIG. 1A, some implementations, a personal electronic device retention apparatus 100 is configured to accept a variety of sizes and shapes of personal electronic devices, for example due to being manufactured at least in part from a flexible material such as an elastomer (e.g., neoprene, rubber, foamed urethane, foamed rubber, bungee cord, etc.), coiled plastic or metal. In some implementations, the retention apparatus 100 is fabricated from a single material (e.g., a contiguously produced material or individual pieces of a same material later fastened together). In other implementations, the retention apparatus 100 includes two or more materials. In some implementations, the retention apparatus 100 is manufactured from a layered material.

The retention apparatus 100 includes a series of retention loops 102 each configured to stretch over and secure the corners of a personal electronic device, thereby releasably retaining the personal electronic device. The retention loops 102, for example, may define openings 106 through which the corners of the personal electronic device are configured to protrude upon engagement with the retention apparatus 100. In other implementations, the centers of the retention loops 102 (e.g., positioned at openings 106) may be constructed of flexible material for snugly engaging the corners of the personal electronic device. Although illustrated with four retention loops 102, more or fewer retention loops may be included, for example based upon a particular design of personal electronic device.

The retention apparatus 100 also includes a strap 104 provided to assist in securing the retention apparatus 100 to a protective device. Although illustrated as a single strap 104, in other implementations, two or more straps may be provided (e.g., both horizontal and vertical, as a split strap 104, etc.). The strap 104, in some implementations, may be configured to mate with or otherwise secure to interior and/or exterior features of the protective device, securing the retention apparatus 100 to the protective device. In other implementations, the strap 104 may be configured to mate with and/or otherwise secure to a protective encasement portion of the protective device. In further implementations, the strap 104 may be configured to mate with and/or otherwise secure to a separate functional or structural component of a retention assembly which, in turn, is configured to mate with and/or otherwise secure to the protective device (or a protective encasement portion thereof).

Turning to FIG. 1B, in some implementations, a personal electronic device retention apparatus, such as the retention apparatus 100 described in relation to FIG. 1A, includes a strap 120 (e.g., such as strap 104 described in relation to FIG. 1A) with a midpoint 122 being approximately centered on the personal electronic device retention apparatus. The midpoint 122, in some implementations, is positioned such that it substantially aligns with at least one of a center of the personal electronic device and a center of gravity of the personal electronic device. In some implementations, at least one of the ends 124 of the strap 120 is accessible from the outside of the protective device wherein the personal electronic device is retained. For example, upon engaging the personal electronic device with the personal electronic device retention apparatus, the strap 120 may be secured to the protective device such that the personal electronic device is retained firmly within the protective device.

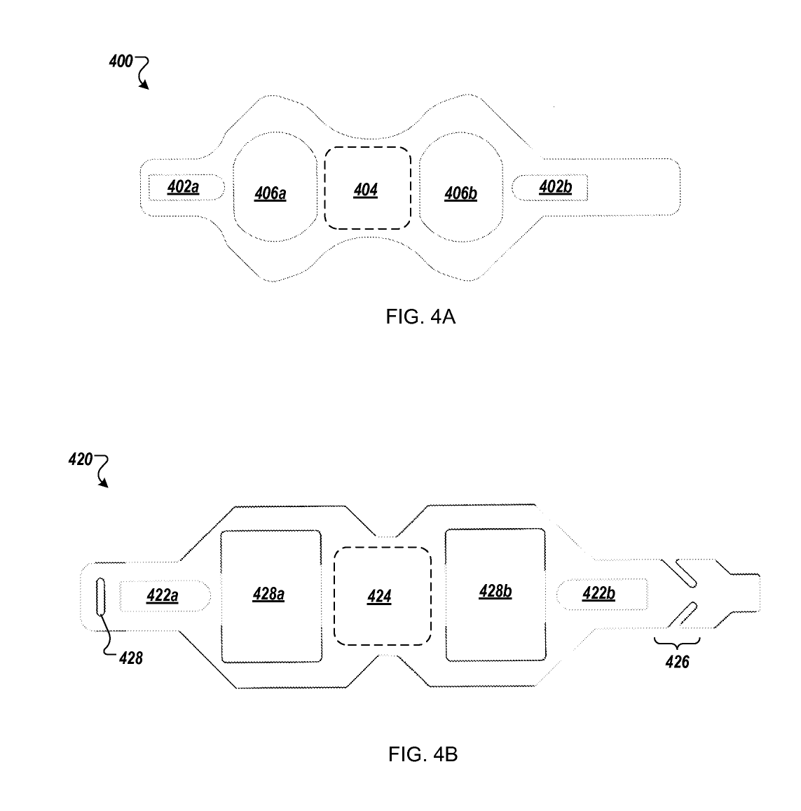

Turning to FIG. 2, in some implementations, a retention apparatus 200 for retaining a personal electronic device within a protective device includes two or more sets of retention loops, such as a set of inner loops 202 and a set of outer loops 204. The set of inner loops 202a, 202b, as illustrated, are further segmented into corner portions by corner recesses 206 (e.g., openings or flexible engagement material for snugly retaining a corner of a personal electronic device). The set of inner loops 202a, 202b, for example, may be manufactured of elastomeric material or other flexible material configured to snap over and snugly retain edge portions of a personal electronic device, such as materials described in relation to retention apparatus 100 of FIG. 1A.

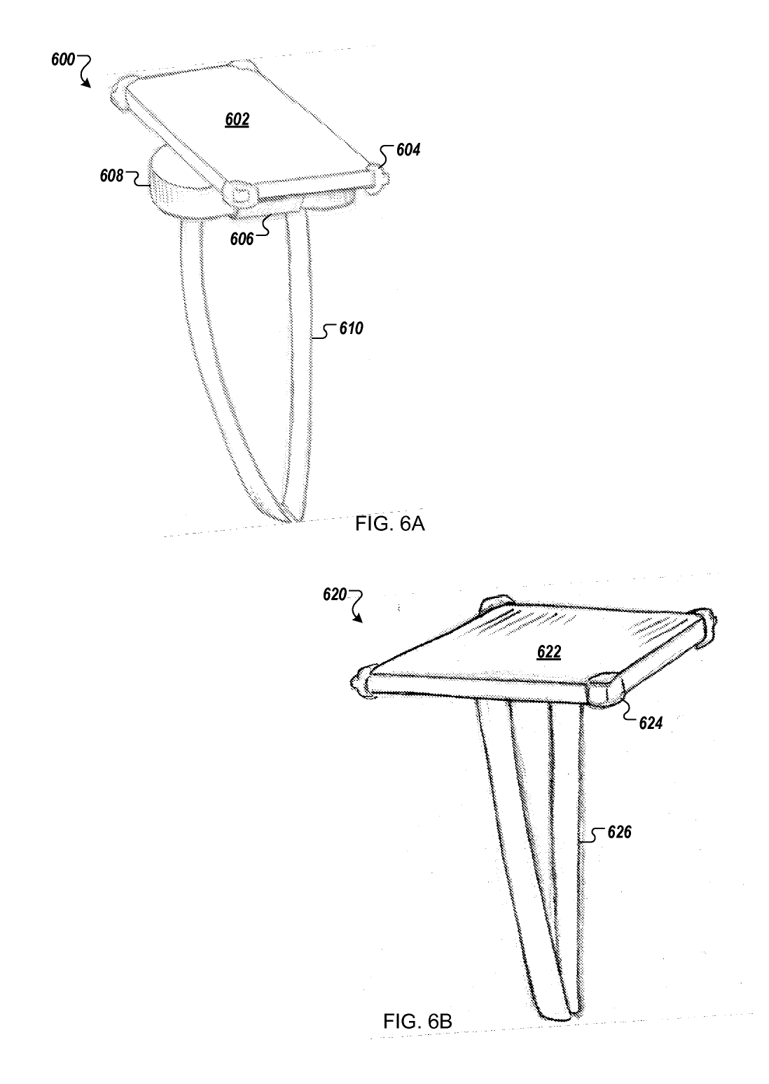

The outer loops 204 of the retention apparatus 200, in some implementations, are configured to snap over and retain a separate device, such as a peripheral unit including one or more peripheral devices configured to be in communication with the personal electronic device. The peripheral unit, for example, may be presented within a protective encasement, such as an accessory block configured for insertion within the protective device (described further below, for example in relation to FIG. 5A). In other implementations, the outer loops 204 may be configured to snap over additional structural components of the personal electronic device and/or structural components of the protective device (or protective encasement portion of the protective device).

As illustrated, the retention apparatus 200 includes a strap portion 208. The strap portion 208, for example, may enable attachment of the retention apparatus 200 to the protective device or a protective encasement portion thereof, for example as described in relation to strap 120 of FIG. 1B.

In some implementations, the retention apparatus 200 is fabricated from a single material (e.g., cut from a single sheet of material, molded as a single element, etc.). In other implementations, the retention apparatus 200 is formed from two or more materials and/or pieces, each of which may be joined together in a permanent or releasable manner. In some examples, individual pieces of the retention apparatus 200 may be welded, sewn, fused, snapped, and/or glued together during manufacture.

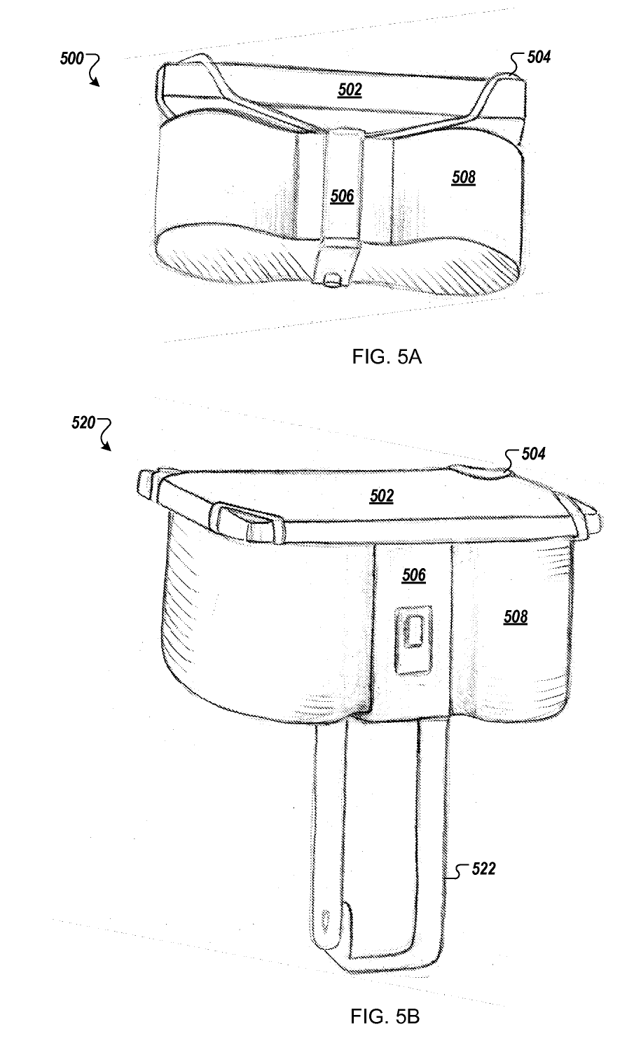

Turning to FIG. 3, in some implementations, a retention apparatus 300 for retaining a personal electronic device within a protective device includes one or more finger holds 302 configured to aid a user to grasp a series of corner loops 304 when installing a personal electronic device within a protective device using the retention apparatus 300. The finger holds 302, in some implementations, include perforations or cut-away portions. In some implementations, the finger holds 302 include a textured portion of material to provide resistance from slippage when a user pulls at the finger holds 302. The finger holds 302 may include additional material (e.g., fused to, glued to, sprayed onto, formed within, or otherwise added to the material of the loops 304) having properties configured to aid in maintaining grip with fingertips.

In some implementations, the retention apparatus 300 includes one or more fixtures (connectors, fasteners) within an obstruction-free region 306. The fixtures may be provided upon one or both sides of the retention apparatus 300 (e.g., a side facing the personal electronic device and a side opposite the side facing the personal electronic device). The fixtures, for example, may be used to fasten the personal electronic device to the retention apparatus 300 and/or fasten the retention apparatus to the protection device (or protective encasement thereof). In some examples, the fixtures may include one or more of hook and loop material, magnets, snaps, hooks, and other fasteners.

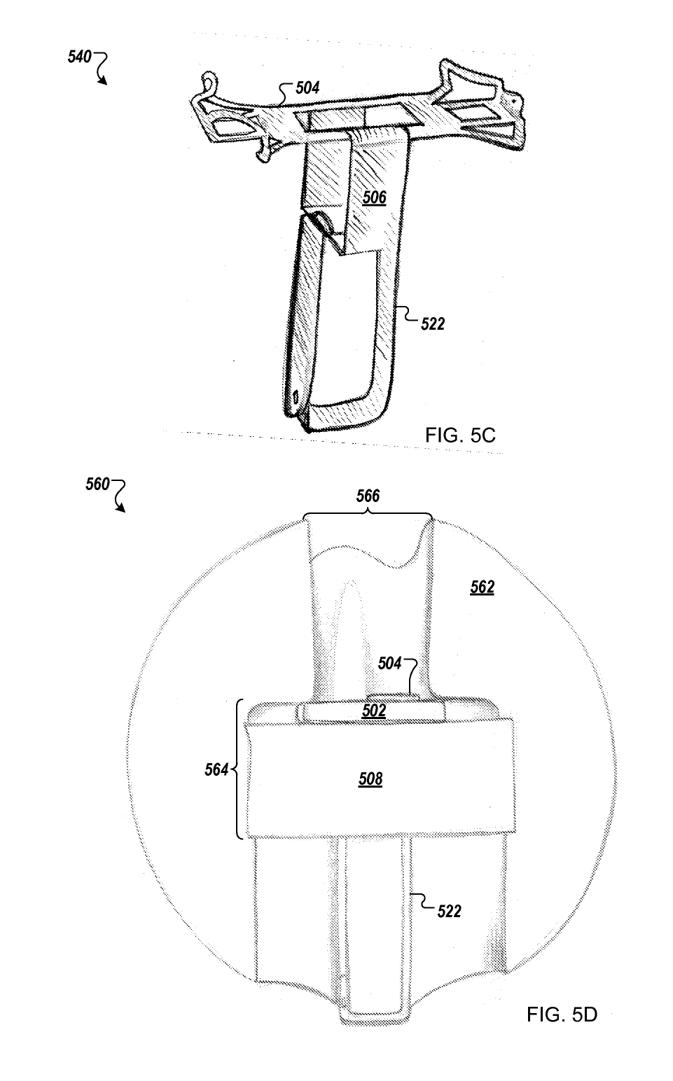

FIGS. 4A and 4B illustrate example straps configured to fasten, for example, to the obstruction-free region 306. Turning now to FIG. 4A, a strap 400 includes notches (or voids) 402, enabling precise calibration of the stretch and the lay of the strap 400 on the underlying surfaces. Turning to FIG. 4B, a strap 420 similarly includes notches 422. The strap 420 may be releasably engaged to the obstruction-free region 306 of the retention apparatus 300 (described in relation to FIG. 3) via a fixture provided within an obstruction-free region 424. Returning to FIG. 4A, the strap 400 may similarly be releasably engaged to the obstruction-free region 306 of the retention apparatus 300 (described in relation to FIG. 3) via a fixture provided within an obstruction-free region 404.

Further, turning now to FIG. 4B, the strap 420 includes one or more notches 426 mateable to cut-outs 428 such that, upon insertion of the notch 426 within the cut-out 428 the strap 420 releasably locks into a loop. The loop, in some implementations, may retain the strap 420 (e.g., and the personal electronic device secured to the retention apparatus 300 illustrated in FIG. 3) to the protective device or a protective encasement portion thereof. In some implementations, the loop may retain the strap 426 to a removable insert (e.g., accessory block) configured for installation within the personal electronic device receptacle of the protective device.

The removable insert, in some implementations, includes peripheral devices configured for communication with the personal electronic device such as, in some examples, one or more speakers, sensors, microphones, light elements, and/or memory devices. In some implementations, a set of voids 428 are configured to mate with structures (e.g., appendages, buttons, hooks, etc.) provided upon the exterior of the removable insert. As illustrated in FIG. 4A, strap 400 similarly includes a set of voids 406 configured to mate, in some implementations, with structures provided upon the exterior of a removable insert.

FIGS. 5A through 5D illustrate example retention apparatus assemblies possible using retention apparatus components similar to those described in relation to FIGS. 1A, 1B, 2, 3, 4A, and 4B above. The retention apparatus assemblies, for example, may be configured for removable installation within a protective device, such as a sporting equipment device.

Turning to FIG. 5A, a first retention apparatus assembly 500 includes a personal electronic device retention element 504 configured to releasably retain a personal electronic device 502 via a set of flexible corner loops. The personal electronic device retention element 504, in some examples, may be similar to the retention apparatus 100 of FIG. 1A, retention apparatus 200 of FIG. 2, or retention apparatus 300 of FIG. 3. The personal electronic device retention element 504 is releasably connected to an accessory block 508 via a strap 506. In some implementations, the strap 506 is manufactured as part of the personal electronic device retention element 504, for example as illustrated by the retention apparatus 100 of FIG. 1A and the retention apparatus 200 of FIG. 2. In other implementations, the strap 506 is releasably connected to the personal electronic device retention element 504. For example, as previously described in relation to the retention apparatus 300 of FIG. 3, the strap 506 (e.g., strap 400 of FIG. 4A or strap 420 of FIG. 4B) may be connected to the personal electronic device retention element 504 using a connection fixture. In a particular example, the strap 506 may be connected to the personal electronic device retention element 504 via hook and loop material.

As illustrated, the strap 506 is fastened around the accessory block 508. The accessory block may be designed to snugly conform to a portion of an interior structure of the protective device such that, upon installation of the accessory block within a receptacle area of the protective device, the accessory block 508 is held by tension within the receptacle area. In some implementations, the accessory block is manufactured at least in part from deformable material (e.g., foam, gel foam, etc.) configured to expand to the dimensions of the receptacle area upon insertion. The accessory block 508, in some implementations, includes one or more textured regions configured to increase friction between the accessory block 508 and the internal contour of the receptacle area. For example, grooves designed upon the accessory block 508 may be configured to mate with grooves designed within the receptacle area of the protective device. The grooves on either part may be designed to interlock with the opposing part, hence providing a locking mechanism to help secure the block into the protective device.

The accessory block 508, in some implementations, includes one or more structural components, such as, in some examples, weights, sound enhancing materials, impact absorbing materials, and/or moisture wicking materials. The structural components, for example, may be used to increase protection of the personal electronic device and/or enhance interaction with the protective device.

Additionally or alternatively, in some implementations, the accessory block 508 includes one or more functional components such as, in some examples, one or more of an accelerometer, a positioning sensor, an orientation sensor, a global positioning sensor, a gyroscope, a light sensor, an imaging sensor, an acoustic sensor, a microphone, a camera, one or more light elements (e.g., light-emitting diodes, etc.), and/or a memory device. In some implementations, one or more electronic connectors may be provided external to the accessory block 508, for example to physically connect one or more functional components to the personal electronic device 502. For example, a speaker component within the accessory block 508 may be connected by wire to an audio port of the personal electronic device 502.

Although illustrated as having the strap 506 connecting the accessory block 508 to the personal electronic device retention element 504, in other implementations (not illustrated), the personal electronic device retention element 504 may directly connect to the accessory block 508, for example via a series of second flexible loops. For example, turning to FIG. 2, the second loops 204 may be used to secure the accessory block 508 to the retention apparatus 200.

Turning to FIG. 5B, a second strap 522 may be added to the retention assembly 500 of FIG. 5A to provide an enhanced retention assembly 520. The second strap 522, in some implementations, is fixedly or releasably connected to the first strap 506. In other implementations, the second strap 522 is fixedly or releasably connected to the accessory block 508. The second strap may be used to releasably attach the enhanced retention assembly 522 to the protective device (described in further detail in relation to FIG. 5D). Turning to FIG. 5C, an additional view 540 of the enhanced retention assembly 520, without the accessory block 508, demonstrates an example interconnecting configuration of the personal electronic device retention element 504, the first strap 506, and the second strap 522.

FIG. 5D illustrates a cross-sectional view 560 of the enhanced retention assembly 520 installed within a receptacle area 564 of a protective device 562. The enhanced retention assembly 520, including the personal electronic device retention element 504, the first strap 506 (not visible within the cross-sectional view 560), the accessory block 508, and the second strap 522 provide support to secure the personal electronic device 502 within the receptacle 564 and to prevent the personal electronic device 502 from being ejected from the protective device 562 via an opening 566 (e.g., upon sharp impact or other strong force applied to the protective device 562).

As illustrated, the second strap 522 extends external to an exterior shell of the protective device 562. Upon installation, for example, a user may tighten and lock the second strap 522 to itself against the exterior shell of the protective device 562 (e.g., via strap openings provided opposite the opening 566). The locking fixture upon the strap 522, in some implementations, is designed to be positioned within the protective device 562. For example, an exit point for the strap 522 may be sufficiently sized such that a user may lock the strap 522 into a loop without having a fixture exposed upon the exterior of the protective device. In some implementations, strap channels are configured between the personal electronic device receptacle 564 and the bottom of the protective device 562, such that the strap 522 feeds through the strap channels. In other implementations, the protective device 562 is substantially hollow beneath the personal electronic device receptacle 564, with two strap openings positioned at the bottom of the protective device 562 for securing the strap 522 to the protective device 562. In another example, locking fixtures provided upon the exterior shell of the protective device 562 (not illustrated) may secure the strap 522 to the protective device 562. In some implementations, after locking the strap 522 to the protective device 562, a protective device cover (not illustrated) may be added to the protective device 562, obscuring the strap 562 from view. For example, a slip cover manufactured from stretchable fabric may be pulled onto the protective device 562.

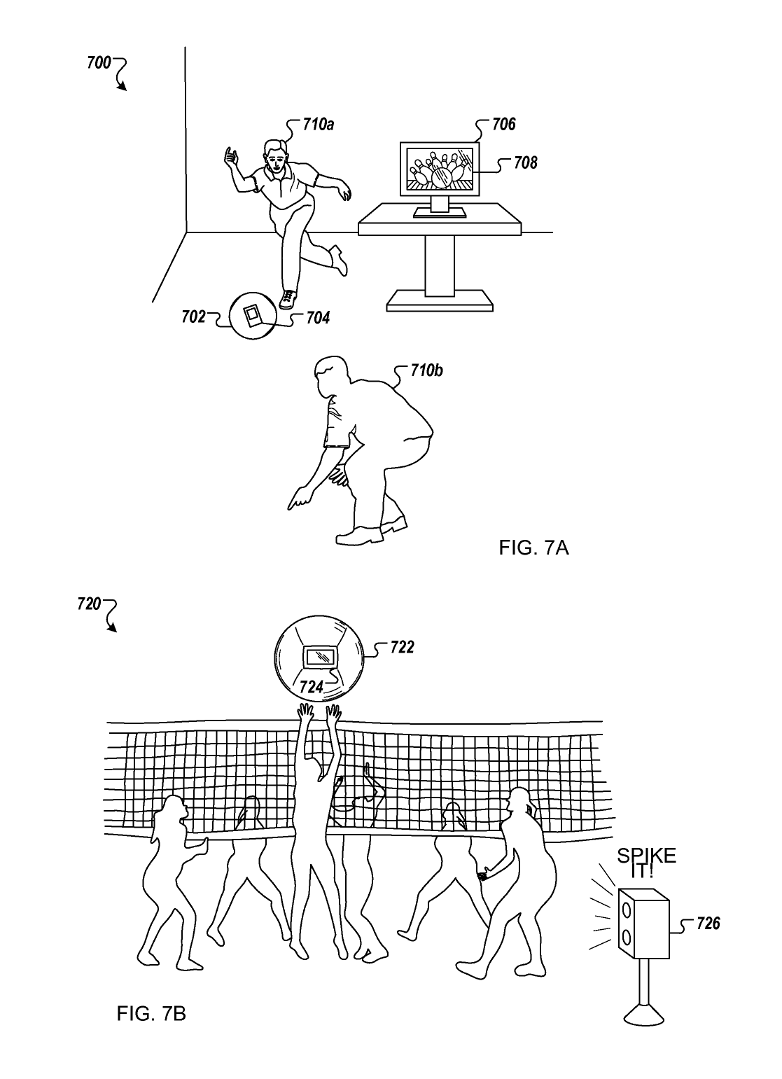

FIGS. 6A and 6B illustrate additional example retention apparatus assemblies possible using retention apparatus components similar to those described in relation to FIGS. 1A, 1B, 2, 3, 4A, and 4B above. The retention apparatus assemblies, for example, may be configured for removable installation within a protective device, such as the protective device 562 illustrated in FIG. 5D.

Turning to FIG. 6A, an example retention assembly 600 includes a personal electronic device retention element 604 securing a personal electronic device 602 to the retention assembly 600. The personal electronic device retention element 604, in turn, is connected (fixedly or removeably) to a strap 606 which is secured about an accessory block 608. The retention assembly 600 may be secured to a protective device via a second strap 610, fixedly or removeably connected to at least one of the strap 606 and the accessory block 608. The second strap 610, unlike the strap 522 of FIGS. 5B through 5D, is not illustrated with a locking element (e.g., such as the notch 426 and slot 428 described in relation to the strap 420 of FIG. 4B). In some implementations, the protective device includes a locking mechanism for locking the strap to the protective device. Locking mechanisms, in some examples, can include hooks, snaps, pockets, cavities, hook and loop, and custom securing shapes.

Turning to FIG. 6B, an additional example retention assembly 620 includes a personal electronic device retention element 624 securing a personal electronic device 622 to a strap 626 without an intermediary strap around an accessory block. The strap 626, for example, may be removeably or fixedly attached to the personal electronic device retention element 624.

Although the retention assemblies are each illustrated in relation to securing a personal electronic device within a protective device, in other implementations (not illustrated), an accessory block may be configured to be in wireless communication with a computing device (e.g., personal electronic device, tablet computer, desktop computer, laptop computer, smart TV, etc.) external to the protective device. The retention apparatus, in this circumstance, may retain the accessory block within the protective device such that the accessory block is swappable with additional accessory blocks (e.g., accessory blocks containing different peripheral elements or having varying weights, etc.).

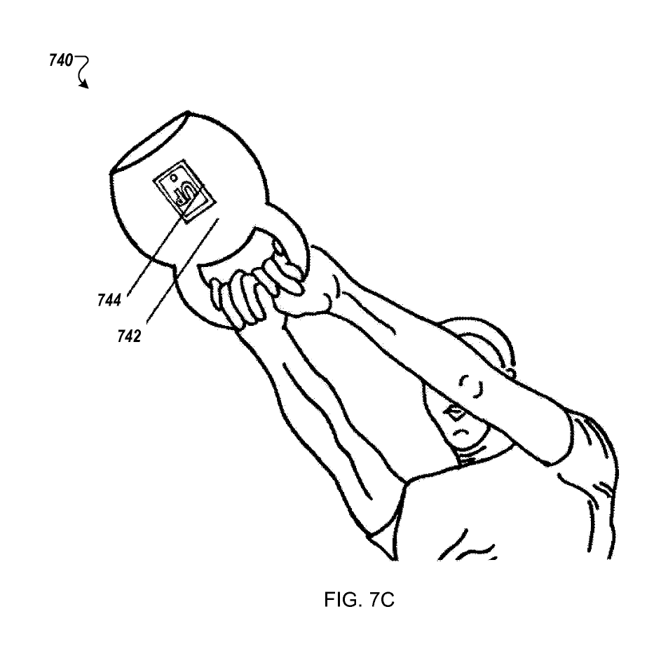

FIGS. 7A through 7C illustrate various protective devices and activities enabled thereby. The physical activities demonstrated within FIGS. 7A through 7C, for example, may involve jarring movements and/or striking of the protective device, during which secure retention of the physical electronic device may be aided via the various retention apparatus and/or assemblies described above. The activities illustrated within FIGS. 7A through 7C are for illustrative purpose only and are not meant to limit in any way the form of the protective device or the activities enabled by the protective device. Additional embodiments of protective devices and activities enabled thereby are provided within related application Ser. No. 13/348,433, filed on Jan. 11, 2012, and titled “Physical Interaction Device for Personal Electronics and Method for Use” and Ser. No. 13/348,434, filed on Jan. 11, 2012, and titled “Physical Interaction Device for Personal Electronics and Method for Use.”

Turning to FIG. 7B, an example media-rich sporting activity 720, in some implementations, may include a ball-shaped protective device 722 encasing a personal electronic device 724 in wireless communication with remote audio equipment 726. The ball-shaped protective device 722, in some examples, may be similar to an inflatable beach ball or a volleyball. Although illustrated as being visible, in some implementations the ball-shaped protective device 722 may completely surround and obscure the personal electronic device 724. In some implementations, a software application installed upon the personal electronic device 724 may interact in real-time with the remote audio equipment 726 to engage the players (e.g., during a game of volleyball), for example, with commentary or to relay scoring information. In some implementations, the ball-shaped protective device 722 may include a water tight enclosure configured to protect the personal electronic device 724 from physical impact and environmental impacts such as sand, water, and snow.

Turning to FIG. 7A, in some implementations, a ball-shaped protective device 702 may be used in conjunction with a bowling alley software application. The ball-shaped protective device 702 encloses a personal electronic device 704 executing a bowling application to enable bowling interactive play, as illustrated in an activity diagram 700. The bowling application may include software modules designed to interpret data received by one or more sensors resident within the personal electronic device 704 and/or in communication with the personal electronic device 704 to recognize movement from the ball-shaped protective device 702. In some implementations, when a software module executing upon the personal electronic device 704 interprets sensor input indicative of movement related to rolling the ball-shaped protective device 702, the personal electronic device 704 may display movement in a scene on a screen area of the personal electronic device 704. The personal electronic device 704, in some implementations, may communicate display information to a remote display 706, causing the display of movement in a scene 708 upon the remote display 706 (e.g., personal computer monitor, LCD display, television, or smart television (STV), etc.). For example, as illustrated, a trajectory of the ball-shaped protective device 702 may be interpreted in relation to striking virtual bowling pins (e.g., as illustrated on the remote display 706). For example, the scene 708 on the remote display 706 may graphically illustrate the play action in real time (e.g., in a video mode). In some implementations, coordination between multiple personal electronic devices in multiple ball-shaped protective devices enables multiple players 710 to compete in bowling. Coordination between the multiple ball-shaped protective devices, in some examples, may be achieved by local or remote wireless communication such as, in some examples, radio frequency (RF) transmissions, Bluetooth® transmissions, cellular transmissions, or Wi-Fi™ transmissions.

In some implementations, when a protective device, such as the ball-shaped protective device 702, is designed to be rolled by a user, the game involves direct review of information upon the screen of the personal electronic device (e.g., personal electronic device 704) rather than on a remote display (e.g., remote display 708). In these circumstances, it may be beneficial to design the protective device to stop in a default upright position such that the screen is visible to the user. For example, when a small child is playing a rolling, kicking, or tossing game with a protective device, to encourage ease of review of information displayed in a screen area of a personal electronic device installed within the protective device, it may be beneficial to include one or more off-setting weights within the protective device positioned away from the center of mass of the protective device, thereby modifying the physical and motion characteristics of the protective device.

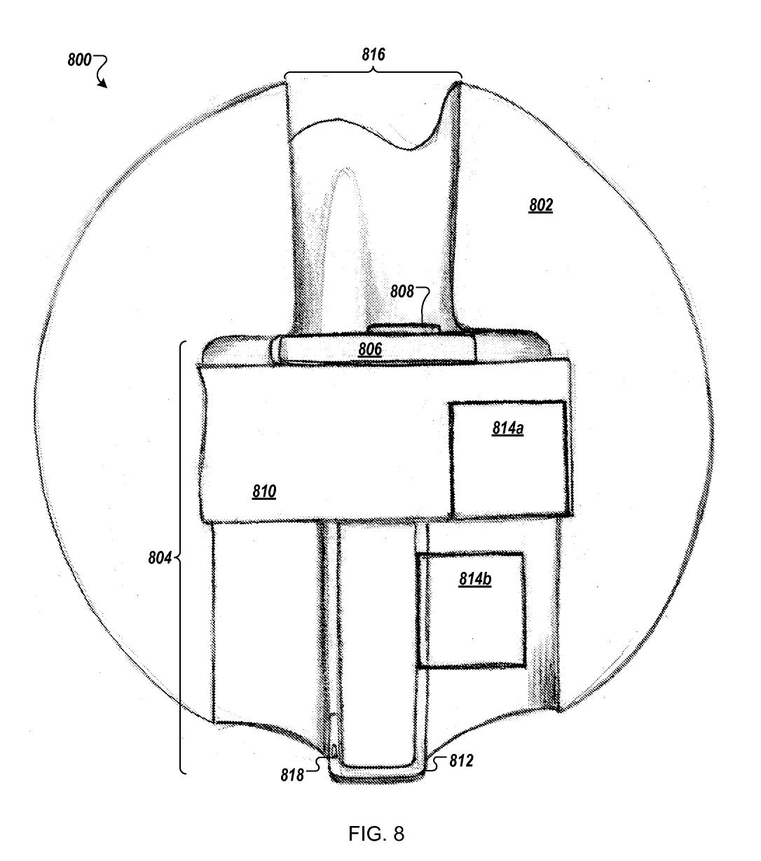

Turning to FIG. 8, a cross-sectional view 800 of a protective device 802 illustrates a personal electronic device 806 retained by a retention assembly 804 including a personal electronic device retention element 808, an accessory block 810, and a strap 812. In some implementations, an offsetting weight 814a is included within the accessory block 810. For example, for particular game play, the accessory block 810 may be added to the retention assembly 804 installed within the protective device 802. The application software in the personal electronic device 806, in combination with one or more sensors (e.g., built into the personal electronic device 806 or in communication with the personal electronic device 806 from the accessory block 810, etc.) can take advantage of the known resting position of the protective device 802 for display, user interaction, and processing purposes. For example, the offsetting weight 814a may cause the protective device 802 to center itself on the surface it is rolling on, when its motion decreases to a stopped position, thereby stopping with an opening 816 in a generally upward position, allowing a display region of the personal electronic device 806 to be visible to a user.

The protective device 802, in some implementations, may be sold together with two or more accessory blocks, each accessory block configured for a different style of play. In addition to the offsetting weight 814a, in some implementations, the accessory block 810 may include other structural or functional elements, such as, in some examples, speakers, sensors, and/or shock absorbing materials.

In some implementations, in addition to or in lieu of the offsetting weight 814a within the accessory block 810, the protective device 802 may include an offsetting weight 814b (e.g., removeably or fixedly positioned within a weight cavity region of the protective device 802).

The offsetting weight 814b, in some implementations, is designed as part of the strap 812. For example, the strap 812 includes two sides locked together using a locking mechanism 818. The side of the strap 812 including the offsetting weight 814b, for example, may include one or more weighted elements fixedly or removeably attached to the strap 812. In another example, the side of the strap 812 including the offsetting weight 814b may be composed of a heavier material or layered with a heavier material than the opposing side of the strap 812.

In some implementations, rather than or in addition to providing weight in a position to off-set the center of mass of the protective device to manipulate the behavior of the protective device while in motion, weight may be added to a sporting equipment protective device as an exercise (e.g., weight training) aid.

Turning to FIG. 7C, an athletic device 742 may be embedded with a personal electronic device 744 to enable, for example, an interactive exercise or rehabilitative activity such as is displayed in an exercise scene 740. As illustrated in the exercise scene 740, for example, the athletic device 742 (e.g., a kettlebell style weight), may hold the personal electronic device 744 (e.g., within a protective enclosure) which, in turn, may execute an exercise regimen application. In some implementations, the exercise regimen application determines behaviors of the user through one or more sensor inputs, thereby tracking progress of the user. In some examples, an exercise regimen application may collect information regarding velocity, height, repetitions, and/or timing while a user performs various exercise activities.

In some implementations, an exercise regimen application provides instructions (e.g., “higher”, “slow down”, etc.) and/or messages of encouragement (e.g., “just two more lifts”, “you can do it”, etc.) to the user. Audio prompts, in some implementations, may be provided through one or more separate or external speakers, for example using a wireless headphone device, a speaker built into the athletic device 742, or communication with an external device such as a personal computer, television, or display monitor. In this manner, for example, the personal electronic device 744 may be encased safely within the athletic device 742 without the need to provide sound-transmission capabilities from a built-in speaker. In some implementations, an exercise regimen application may provide instructions to a user to perform particular strength building and/or rehabilitation activities.

In some implementations, the athletic device 742 includes a retention assembly containing a weighted accessory block to adjust the weight of the athletic device 742. For example, the athletic device 742 may be sold with two or more accessory blocks, each accessory block adding a particular weight to the athletic device 742 (e.g., one pound, two pounds, five pounds, etc.). The user, to increase the impact of an exercise routine incorporating the athletic device 742, may swap an accessory block of increased weight into a retention assembly installed within the athletic device 742. In some implementations, the application installed upon the personal electronic device may derive the present weight installed within the retention assembly. For example, an RFID chip or other wireless signature may be included within the accessory block such that the accessory block may be read by the personal electronic device to identify the current weight. In other implementations, the user may manually enter the weight of the accessory block into the application (e.g., through a user interface or by scanning machine-readable indicia marked upon the accessory block, using the personal electronic device, prior to installing the accessory block within the athletic device 742).

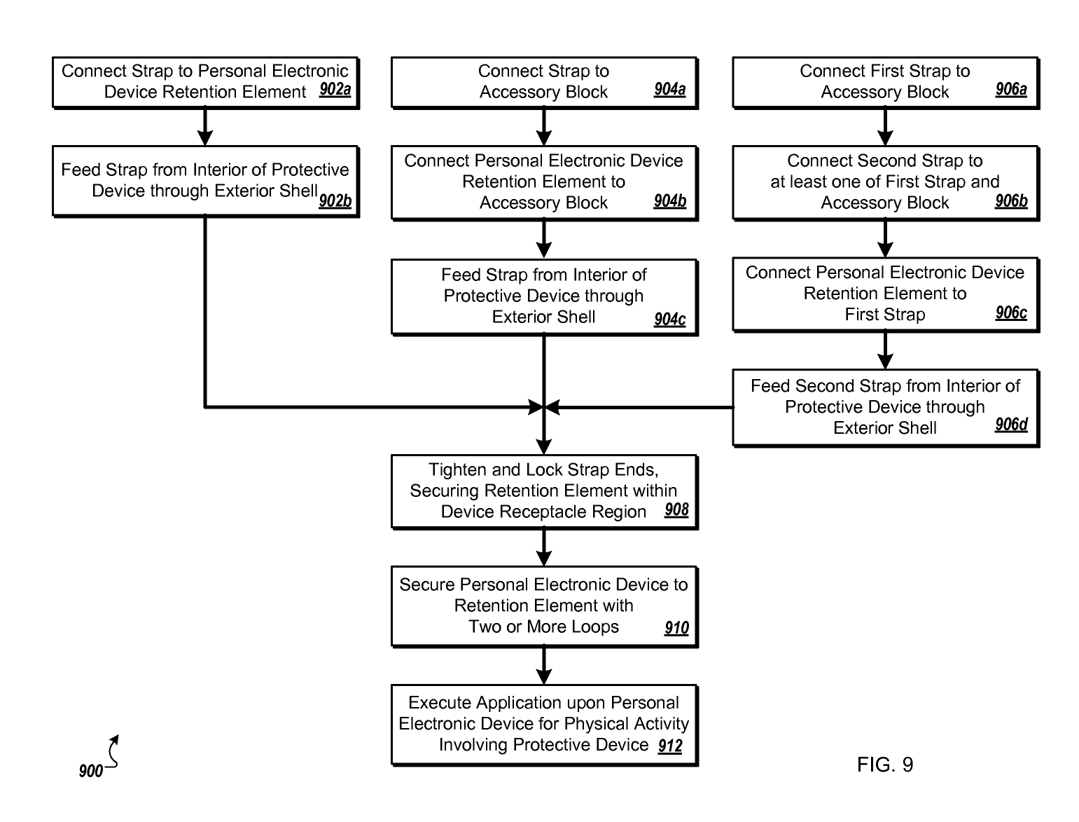

FIG. 9 is a flow chart illustrating an example method 900 for installing and using a retention assembly within a protective device. The method 900, for example, may be performed to install any of the retention assemblies (e.g., retention assembly 520 of FIG. 5B, retention assembly 600 of FIG. 6A, retention assembly 620 of FIG. 6B, retention assembly 804 of FIG. 8, etc.) described above. In another example, the method 900 may be performed to assemble a different variation of retention assembly, composed of one or more of the parts described in relation to FIGS. 1A, 1B, 2, 3, 4A, and 4B.

The method 900 generally begins with assembling a retention assembly. In some implementations, one or more of the assembly steps may be performed by a manufacturer of the retention assembly. The assembly, in some implementations, may be performed in part or in full by a user of the protective device prior to interaction with the personal electronic device via the protective device.

In some implementations, assembling the retention assembly begins with connecting a strap to a personal electronic device retention element (902a). For example, turning to FIG. 6B, the strap 626 may be fixedly or releasably connected to the personal electronic device retention element 624.

In some implementations, the strap is fed from an interior of the protective device through an exterior shell (902b). As illustrated in the cross-sectional view 560 of FIG. 5D, the strap 522 is fed through the protective device 562 to the exterior of the protective device 562.

In another version of retention assembly, in some implementations, assembling the retention assembly begins with connecting a strap to an accessory block (904a). For example, turning to FIG. 6A, the strap 610 may be connected to the accessory block 608.

In some implementations, a personal electronic device retention element is connected to the accessory block (904b). In a first example, the personal electronic device retention element may be connected to the accessory block via one or more flexible (e.g., elastomer) loops, such as the loops 204 illustrated in relation to retention apparatus 200 of FIG. 2. In another example, the personal electronic device retention element may include a built-in strap for connection to the accessory block, such as the strap 208 of the retention apparatus 200 described in relation to FIG. 2.

In some implementations, the strap connected to the accessory block is fed from an interior of the protective device through an exterior shell (904c). As illustrated in the cross-sectional view 560 of FIG. 5D, the strap 522 is fed through the protective device 562 to the exterior of the protective device.

In a further version of a retention assembly, assembling the retention assembly begins with connecting a first strap to an accessory block (906a). For example, the first strap 506 may be connected to the accessory block 508, as illustrated in FIG. 5A.

In some implementations, a second strap may be connected to at least one of the first strap and the accessory block (906b). In some implementations, the second strap is fixedly connected to the first strap, for example during a manufacturing process. The first strap and the second strap, for example, may be manufactured in part from a contiguous piece of material. In some implementations, the second strap is removeably connected to the first strap. The second strap, in some implementations, may be removeably or fixedly joined to the accessory block.

In some implementations, the personal electronic device retention element is connected to the first strap (906c). In some implementations, the first strap is included within the personal electronic device retention element, as illustrated by the strap 104 of retention apparatus 100 illustrated in FIG. 1A. In other implementations, the personal electronic device retention element is fixed to the first strap via one or more fixture elements. For example, as illustrated in FIG. 3, the retention apparatus 300 may be connected to a strap (e.g., strap 400 or 420) via one or more fixtures provided within the region 306. In a particular example, the personal electronic device retention element may be connected to the first strap by Velcro®.

In some implementations, the second strap is fed from an interior of the protective device through an exterior shell (906d). As illustrated in the cross-sectional view 560 of FIG. 5D, for example, the strap 522 is fed through the protective device 562 to the exterior of the protective device 562.

Regardless the assembly method and style of retention assembly used, after feeding a strap from the interior of the protective device through the exterior shell, in some implementations, the strap ends are tightened and locked, thereby securing the personal electronic device retention element within the personal electronic device receptacle region of the protective device (908). In some implementations, the strap ends include a locking mechanism for locking in a loop formation (e.g., such as a belt configuration, notches and a slot (see FIG. 4B), or other locking mechanism). In some implementations, the exterior shell of the protective device includes one or more locking elements for locking the strap ends.

In some implementations, the personal electronic device is secured to the personal electronic device retention element with one or more loops (910). For example, elastomer loops may be positioned around each corner of the personal electronic device to secure the personal electronic device to the personal electronic device retention element.

In some implementations, a software application is executed upon the personal electronic device for enabling a particular physical activity game involving the protective device (912). For example, a video-enhanced bowling game as described in relation to FIG. 7A, a commentary-enhanced volleyball game as described in relation to FIG. 7B, or an electronic personal trainer-enhanced medicine ball workout as described in relation to FIG. 7C may be accomplished using a protective device installed with the retention assembly and personal electronic device, without concern for damage to the personal electronic device via ejection from the protective device.

Although discussed in relation to a particular series of steps, in some implementations, one or more of the steps provided within the method 900 may be performed in a different order and/or one or more steps of the method 900 may be removed. For example, in some implementations, the personal electronic device may be secured to the personal electronic device retention element (910) prior to tightening and locking the strap ends to secure the retention element within the personal electronic device receptacle region of the protective device (908). If using an accessory block, in some implementations, the retention assembly may be installed without first prior addition of the personal electronic device retention element. For example, if the personal electronic device retention element releasably connects to one of the accessory block and a strap surrounding the accessory block, the personal electronic device retention element may be removed and replaced while the remainder of the retention assembly continues to be installed within the protective device.

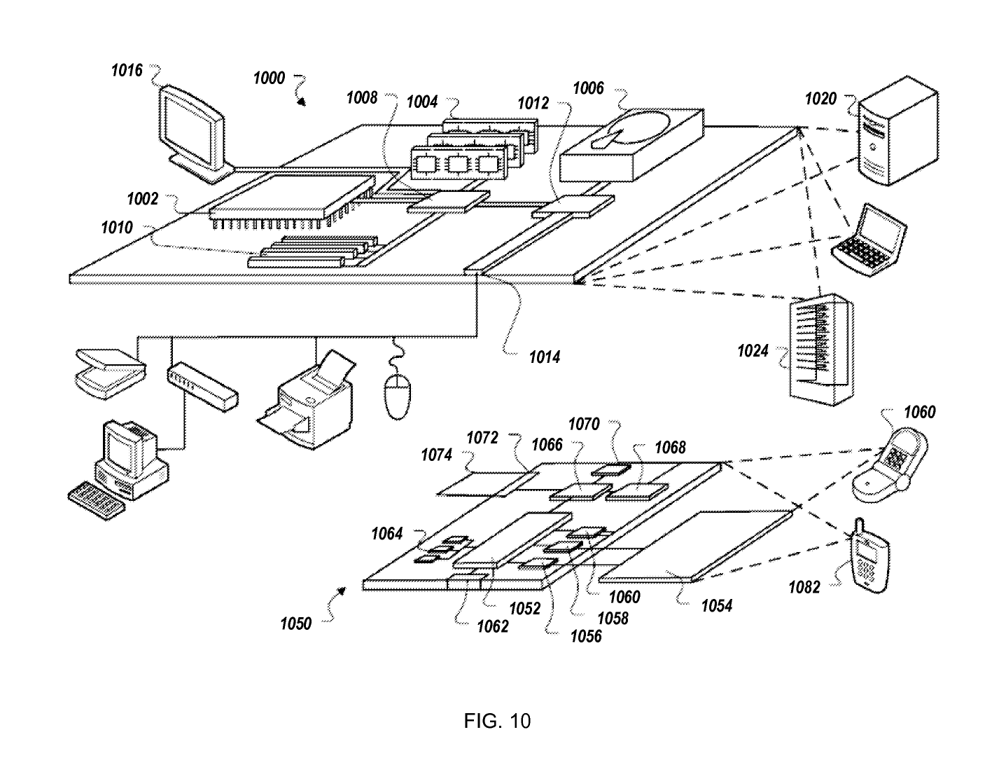

FIG. 10 shows an example of a computing device 1000 and a mobile computing device 1050 that can be used to implement the techniques described in this disclosure. The computing device 1000 is intended to represent various forms of digital computers, such as laptops, desktops, workstations, personal digital assistants, servers, blade servers, mainframes, and other appropriate computers. The mobile computing device 1050 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 1000 includes a processor 1002, a memory 1004, a storage device 1006, a high-speed interface 1008 connecting to the memory 1004 and multiple high-speed expansion ports 1010, and a low-speed interface 1012 connecting to a low-speed expansion port 1014 and the storage device 1006. Each of the processor 1002, the memory 1004, the storage device 1006, the high-speed interface 1008, the high-speed expansion ports 1010, and the low-speed interface 1012, are interconnected using various busses, and may be mounted on a common motherboard or in other manners as appropriate. The processor 1002 can process instructions for execution within the computing device 1000, including instructions stored in the memory 1004 or on the storage device 1006 to display graphical information for a GUI on an external input/output device, such as a display 1016 coupled to the high-speed interface 1008. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 1004 stores information within the computing device 1000. In some implementations, the memory 1004 is a volatile memory unit or units. In some implementations, the memory 1004 is a non-volatile memory unit or units. The memory 1004 may also be another form of computer-readable medium, such as a magnetic or optical disk.

The storage device 1006 is capable of providing mass storage for the computing device 1000. In some implementations, the storage device 1006 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 1002), perform one or more methods, such as those described above. The instructions can also be stored by one or more storage devices such as computer- or machine-readable mediums (for example, the memory 1004, the storage device 1006, or memory on the processor 1002).

The high-speed interface 1008 manages bandwidth-intensive operations for the computing device 1000, while the low-speed interface 1012 manages lower bandwidth-intensive operations. Such allocation of functions is an example only. In some implementations, the high-speed interface 1008 is coupled to the memory 1004, the display 1016 (e.g., through a graphics processor or accelerator), and to the high-speed expansion ports 1010, which may accept various expansion cards (not shown). In the implementation, the low-speed interface 1012 is coupled to the storage device 1006 and the low-speed expansion port 1014. The low-speed expansion port 1014, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 1000 may be implemented in a number of different forms, as shown in the figure. For example, it may be implemented as a standard server 1020, or multiple times in a group of such servers. In addition, it may be implemented in a personal computer such as a laptop computer 1022. It may also be implemented as part of a rack server system 1024. Alternatively, components from the computing device 1000 may be combined with other components in a mobile device (not shown), such as a mobile computing device 1050. Each of such devices may contain one or more of the computing device 1000 and the mobile computing device 1050, and an entire system may be made up of multiple computing devices communicating with each other.

The mobile computing device 1050 includes a processor 1052, a memory 1064, an input/output device such as a display 1054, a communication interface 1066, and a transceiver 1068, among other components. The mobile computing device 1050 may also be provided with a storage device, such as a micro-drive or other device, to provide additional storage. Each of the processor 1052, the memory 1064, the display 1054, the communication interface 1066, and the transceiver 1068, are interconnected using various buses, and several of the components may be mounted on a common motherboard or in other manners as appropriate.

The processor 1052 can execute instructions within the mobile computing device 1050, including instructions stored in the memory 1064. The processor 1052 may be implemented as a chipset of chips that include separate and multiple analog and digital processors. The processor 1052 may provide, for example, for coordination of the other components of the mobile computing device 1050, such as control of user interfaces, applications run by the mobile computing device 1050, and wireless communication by the mobile computing device 1050.

The processor 1052 may communicate with a user through a control interface 1058 and a display interface 1056 coupled to the display 1054. The display 1054 may be, for example, a TFT (Thin-Film-Transistor Liquid Crystal Display) display or an OLED (Organic Light Emitting Diode) display, or other appropriate display technology. The display interface 1056 may comprise appropriate circuitry for driving the display 1054 to present graphical and other information to a user. The control interface 1058 may receive commands from a user and convert them for submission to the processor 1052. In addition, an external interface 1062 may provide communication with the processor 1052, so as to enable near area communication of the mobile computing device 1050 with other devices. The external interface 1062 may provide, for example, for wired communication in some implementations, or for wireless communication in other implementations, and multiple interfaces may also be used.

The memory 1064 stores information within the mobile computing device 1050. The memory 1064 can be implemented as one or more of a computer-readable medium or media, a volatile memory unit or units, or a non-volatile memory unit or units. An expansion memory 1074 may also be provided and connected to the mobile computing device 1050 through an expansion interface 1072, which may include, for example, a SIMM (Single In Line Memory Module) card interface. The expansion memory 1074 may provide extra storage space for the mobile computing device 1050, or may also store applications or other information for the mobile computing device 1050. Specifically, the expansion memory 1074 may include instructions to carry out or supplement the processes described above, and may include secure information also. Thus, for example, the expansion memory 1074 may be provide as a security module for the mobile computing device 1050, and may be programmed with instructions that permit secure use of the mobile computing device 1050. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier. that the instructions, when executed by one or more processing devices (for example, processor 1052), perform one or more methods, such as those described above. The instructions can also be stored by one or more storage devices, such as one or more computer- or machine-readable mediums (for example, the memory 1064, the expansion memory 1074, or memory on the processor 1052). In some implementations, the instructions can be received in a propagated signal, for example, over the transceiver 1068 or the external interface 1062.

The mobile computing device 1050 may communicate wirelessly through the communication interface 1066, which may include digital signal processing circuitry where necessary. The communication interface 1066 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 1068 using a radio-frequency. In addition, short-range communication may occur, such as using a Bluetooth®, Wi-Fi™, or other such transceiver (not shown). In addition, a GPS (Global Positioning System) receiver module 1070 may provide additional navigation- and location-related wireless data to the mobile computing device 1050, which may be used as appropriate by applications running on the mobile computing device 1050.

The mobile computing device 1050 may also communicate audibly using an audio codec 1060, which may receive spoken information from a user and convert it to usable digital information. The audio codec 1060 may likewise generate audible sound for a user, such as through a speaker, e.g., in a handset of the mobile computing device 1050. Such sound may include sound from voice telephone calls, may include recorded sound (e.g., voice messages, music files, etc.) and may also include sound generated by applications operating on the mobile computing device 1050.

The mobile computing device 1050 may be implemented in a number of different forms, as shown in the figure. For example, it may be implemented as a cellular telephone 1080. It may also be implemented as part of a smart-phone 1082, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In view of the structure, functions and apparatus of the systems and methods described here, in some implementations, apparatus and methods for retaining a personal electronic device within a protective device are provided. Having described certain implementations of methods and apparatus for supporting interactions with a personal electronic device using a physical interaction-enabling device with a protective enclosure for the personal electronic device, it will now become apparent to one of skill in the art that other implementations incorporating the concepts of the disclosure may be used. Therefore, the disclosure should not be limited to certain implementations, but rather should be limited only by the spirit and scope of the following claims.

What is claimed:

1. An apparatus comprising:
a protective device comprising
an exterior shell, and
a personal electronic device receptacle configured to removably receive a personal electronic device, wherein the personal electronic device is wholly internal to the exterior shell; and
a retention apparatus configured to releasably retain the personal electronic device within the personal electronic device receptacle while the retention apparatus remains installed within the protective device, wherein
the personal electronic device is toollessly releasable from the retention apparatus; wherein
the device is configured to
substantially enclose and protect the personal electronic device within the personal electronic device receptacle during physical activity comprising at least one of rolling the device, throwing the device, kicking the device, and striking the device against another object, and
enable interaction with the personal electronic device while the personal electronic device is substantially enclosed within the device.

2. The apparatus of claim 1, wherein the retention apparatus comprises two or more flexible loops configured to releasably secure the personal electronic device to the retention apparatus.

3. The apparatus of claim 2, wherein the two or more flexible loops comprise an elastomer material.

4. The apparatus of claim 1, wherein:
the retention apparatus is connected to a strap configured to releasably connect to the protective device.

5. The apparatus of claim 4, wherein the retention apparatus is releasably connected to the strap via at least one of a snap, magnets, and hook and loop material.

6. The apparatus of claim 4, further comprising an accessory block, wherein the retention apparatus is releasably connected to at least one of the accessory block and a second strap surrounding the accessory block.

7. The apparatus of claim 6, wherein the second strap is the strap.

8. The apparatus of claim 6, wherein the accessory block comprises at least one of a sensor device, a weight element, a memory device, and an output device.

9. The apparatus of claim 8, wherein the output device comprises a speaker.

10. The apparatus of claim 8, wherein one or more of the sensor device, the memory device, and the output device is configured to physically connect to at least one of an input port and an output port of the personal electronic device.

11. A retention apparatus configured to retain a personal electronic device within a protective device, the retention apparatus comprising:
a personal electronic device retention element comprising two or more retention loops, wherein
the two or more retention loops comprise flexible material, and
each retention loop of the two or more retention loops is configured to stretch over and secure a portion of a personal electronic device; and
a retention strap configured to releasably connect the retention apparatus to an exterior shell of the protective device;
wherein the retention apparatus is configured to replaceably receive the personal electronic device during connection of the retention strap to the exterior shell of the protective device.

12. The retention apparatus of claim 11, wherein the retention strap is fixedly connected to the personal electronic device retention element.

13. The retention apparatus of claim 11, further comprising an accessory block, wherein the accessory block is configured to conform to a portion of an interior structure of the protective device.

14. The retention apparatus of claim 13, wherein the accessory block comprises a compressible material, wherein the compressible material expands to conform to the portion of the interior structure of the protective device.

15. The retention apparatus of claim 13, wherein at least one of the accessory block and the strap comprises a weight configured to offset a center of mass of the protective device upon installation of the retention apparatus and the personal electronic device within the protective device.

16. The retention apparatus of claim 13, wherein the retention strap is connected to one of the accessory block and a second strap connecting the personal electronic device retention element to the accessory block.

17. The retention apparatus of claim 16, wherein the personal electronic device retention element is releasably connected to at least one of the accessory block and the second strap using a hook and loop material.

18. The retention apparatus of claim 11, wherein the two or more retention loops comprise four retention loops configured to secure corresponding four corners of the personal electronic device.

19. A method for retaining a personal electronic device within a protective device during activity, the method comprising:
connecting a strap to a personal electronic device retention element, wherein the personal electronic device retention element comprises two or more flexible loops;
feeding the strap from an interior of the protective device through an exterior shell of the protective device;
tightening the strap and locking a first strap end and a second strap end in place against the exterior shell of the protective device, thereby securing the personal electronic device retention element within a personal electronic device receptacle region internal of the interior of the protective device;
securing the personal electronic device to the personal electronic device retention element via at least two of the two or more flexible loops; and
executing a software application upon the personal electronic device, wherein the software application comprises instructions that, when executed, provide an enhanced experience involving physical activity with the protective device.

20. The method of claim 19, wherein connecting the strap to the personal electronic device retention element comprises:
connecting the personal electronic device retention element to an accessory block, and connecting the strap to the accessory block.
